(19) United States
(12) Patent Application Publication
(10) Pub. No.: US 2024/0140787 A1
(43) Pub. Date: May 2, 2024

(54) MAGNESIUM-BASED SOLID HYDROGEN STORAGE MATERIAL WITH LIQUID PHASE REGULATION FUNCTION AND PREPARATION METHOD THEREOF

(71) Applicant: Anhui University of Technology, Ma'anshan (CN)

(72) Inventors: Yongtao LI, Ma'anshan (CN); Zhikang QIN, Ma'anshan (CN); Xiaoli DING, Ma'anshan (CN); Haiwen LI, Ma'anshan (CN); Tingzhi SI, Ma'anshan (CN); Dongming LIU, Ma'anshan (CN); Qingan ZHANG, Ma'anshan (CN)

(21) Appl. No.: 18/351,859

(22) Filed: Jul. 13, 2023

Related U.S. Application Data
(63) Continuation of application No. PCT/CN2023/094669, filed on May 17, 2023.

(30) Foreign Application Priority Data
Oct. 27, 2022 (CN) 2022113396571

(51) Int. Cl. C01B 3/00

(52) U.S. Cl. CPC C01B 3/0078

(57) ABSTRACT

A magnesium-based solid hydrogen storage material with liquid phase regulation function and a preparation method thereof and an application thereof in an all-solid-state battery are provided, belonging to the technical field of new energy. The magnesium-based solid hydrogen storage material with the liquid phase regulation function includes following raw materials in percentage by mass: 95% of magnesium hydride and 5% of lithium borohydride. Lithium borohydride as an ionic conductor is dispersed on a surface and matrix of magnesium hydride, which provides channels for the rapid hydrogen storage of the magnesium hydride-based materials.

### CROSS-REFERENCE TO RELATED APPLICATIONS

This application is a continuation of PCT/CN2023/094669, filed on May 17, 2023, which claims priority to Chinese Patent Application No. 202211339657.1, filed on Oct. 27, 2022, the contents of which are hereby incorporated by reference.

### TECHNICAL FIELD

The application relates to the technical field of new energy, and in particular to a magnesium-based solid hydrogen storage material with a liquid phase regulation function and a preparation method thereof.

### BACKGROUND

With the consumption of non-renewable energy such as fossil fuels, developing green and renewable energy is a key step to reduce carbon dioxide emissions and reduce excessive consumption of fossil fuels. Among them, hydrogen energy has attracted much attention because of its wide sources, large combustion calorific value and pollution-free combustion products. However, how to realize safe and efficient storage of hydrogen has always been a challenge for practical hydrogen storage applications. At present, the most common hydrogen storage methods are solid hydrogen storage, high-pressure gaseous hydrogen storage, low-temperature liquid hydrogen storage and organic liquid hydrogen storage. Compared with the latter three hydrogen storage methods, solid hydrogen storage has the advantages of high bulk density, high transportation safety and convenient practical use, which has become the research focus of hydrogen storage in recent years.

Among all kinds of hydrogen storage media in solid hydrogen storage system, metal hydride is widely used as a solid hydrogen storage material, which stores a large amount of hydrogen more easily and reversibly under mild conditions. MgH₂ is a potential candidate material with sufficient reserves, wide application, reversible hydrogen absorption and desorption and high theoretical hydrogen storage capacity (7.6 wt % (percentage by weight). However, easy oxidation, high thermodynamic stability and slow desorption kinetics have become the main issues that hinder practical application. At present, it has been reported that these obstacles have been overcome by alloying, nano-confinement and catalyst doping, but there are some shortcomings such as weak affinity of metal hydrogen, agglomeration and instability of nanostructures. The introduction of metal coordination hydride is able to change the hydrogen absorption/desorption path of magnesium hydride and improve its kinetic performance. In recent years, it has been introduced into magnesium-based hydrogen storage systems, but there are still problems such as high thermodynamic stability and complex preparation process.

In patent CN102935997A, lithium borohydride and titanium trifluoride are put into a ball mill tank for ball milling, then heat-treated at a certain temperature and pressure, and finally magnesium hydride is added for ball milling to obtain a composite catalytic hydrogen storage system, which changes the hydrogen storage performance through the catalytic action of additives, and the kinetics performance and cycle performance are not obviously improved, and the preparation process is complicated, and there is mutual reaction during the synthesis treatment.

### SUMMARY

The purpose of this application is to provide a magnesium-based solid hydrogen storage material with liquid phase regulation function and its preparation method, in order to solve the problems existing in the prior art. In this application, magnesium hydride and lithium borohydride are used as raw materials, and a solid hydrogen storage material with superior kinetics performance and stable cycle performance is prepared through simple ball milling treatment (regulation method different from conventional solid phase improvement measures).

In order to achieve the above objectives, the present application provides the following scheme.

According to one technical scheme of the application, a magnesium-based solid hydrogen storage material with liquid phase regulation function includes following raw materials in percentage by mass: 95% of magnesium hydride (MgH₂) and 5% of lithium borohydride (LiBH₄).

According to another technical scheme of the application, a preparation method of the magnesium-based solid hydrogen storage material with liquid phase regulation function includes following steps: mixing raw materials in an inert gas atmosphere according to mass percentage, and performing ball milling to obtain the magnesium-based solid hydrogen storage material (LiBH₄/MgH₂ composite hydrogen storage system).

The preparation of LiBH₄/MgH₂ composite hydrogen storage system by the ball milling is beneficial to improve the hydrogen storage performance of MgH₂, thus promoting the large-scale and practical application of solid hydrogen storage in vehicle-mounted industry.

As an ionic conductor, LiBH₄ is uniformly embedded on the surface of MgH₂, which provides a large number of hydrogen transfer channels and accelerates the kinetics performance. Moreover, LiBH₄ is able to maintain a uniform dispersion state before and after the kinetics cycle, thus inhibiting the growth of magnesium (Mg) grains and improving the cycling stability.

Optionally, a ball-to-material ratio of the ball milling is 40:1.

Optionally, the number of times of the ball milling is 20, the time of each ball milling is 30 minutes (min), and the interval of each ball milling is 2 min.

Controlling the time and interval of each ball milling avoids the adverse effects of high temperature (high temperature causes partial decomposition or interaction of samples) on magnesium-based solid hydrogen storage material.

Optionally, the diameter of the steel ball used in the ball milling is 5-7 millimeters (mm); the rotational speed of the ball milling is 400 revolutions per minute (rpm).

Another technical scheme of the application is the application of the magnesium-based solid hydrogen storage material with liquid phase regulation function in the preparation of hydrogen storage materials.

Another technical scheme of the application is an all-solid-state battery, and the preparation raw materials include the magnesium-based solid-state hydrogen storage material with liquid phase regulation function.

The application discloses the following technical effects.

Firstly, lithium borohydride (ionic conductor) in the magnesium-based solid hydrogen storage material (LiBH₄/MgH₂ composite hydrogen storage system) is dispersed on the surface of magnesium hydride, and as a coordination hydride, lithium borohydride has coordination anions with high ionic conductivity and high activity, such as [BH⁴]⁻, which is used as an intermediate to promote the conduction of H⁻ in magnesium hydride. After six cycles of hydrogen absorption and desorption, the grain size of Mg is uniform, the grain growth is restrained, and the grain shows remarkable kinetics performance and cycling stability. Especially in the process of high temperature desorption, hydrogen is separated from the liquid phase in the form of bubbles. When the hydrogen is applied to the all-solid-state battery, the impedance performance and ion conductivity of the battery are significantly improved.

Secondly, the preparation process of the application is simple, environment-friendly, easy for large-scale preparation and use, and has certain popularization value. In addition, there is no need for heat treatment after ball milling, and the conditions are mild. The raw materials used in the application, such as magnesium hydride (MgH₂), lithium borohydride (LiBH₄), belong to commercial products, are simple and easy to obtain, and the equipment is a planetary ball mill with low costs.

Thirdly, the LiBH₄/MgH₂ composite hydrogen storage system of the application is able to significantly regulate the hydrogen storage performance of MgH₂, and LiBH₄ in the system presents a liquid phase at high temperature, so that hydrogen is able to separate from the liquid borohydride phase in the form of bubbles, and meanwhile, the introduction of LiBH₄ is as a channel for H⁻ diffusion to provide more diffusion paths.

Lastly, the LiBH₄/MgH₂ composite hydrogen storage system of the present application desorbs 7.1 wt % of hydrogen within 40 min at 300° C., which is 10 times higher than that of pure MgH₂, and has good cycling stability in the process of hydrogen absorption and desorption.

### BRIEF DESCRIPTION OF THE DRAWINGS

In order to explain the embodiments of the present application or the technical scheme in the prior art more clearly, the drawings needed in the embodiments will be briefly introduced below. Obviously, the drawings described below are only some embodiments of the present application, and other drawings may be obtained according to these drawings without creative work for ordinary people in the field.

FIG. 1 is a flow chart of preparing a LiBH₄/MgH₂ composite hydrogen storage system according to embodiment 1 of the present application.

FIG. 2 is the X-ray diffraction (XRD) spectrum of a LiBH₄/MgH₂ composite hydrogen storage system before and after cycling prepared in embodiment 1 of the present application.

FIG. 3(a) is transmission electron microscope (TEM) of a LiBH₄/MgH₂ composite hydrogen storage system prepared in embodiment 1 of the present application.

FIG. 3(b) is a fast fourier transform image of a LiBH₄/MgH₂ composite hydrogen storage system prepared in embodiment 1 of the present application.

FIG. 3(c) is a lattice image of a LiBH₄/MgH₂ composite hydrogen storage system prepared in embodiment 1 of the present application.

FIG. 3(d) is a fast fourier transform image of a LiBH₄/MgH₂ composite hydrogen storage system prepared in embodiment 1 of the present application.

FIG. 3(e) is a lattice image of a LiBH₄/MgH₂ composite hydrogen storage system prepared in embodiment 1 of the present application.

FIG. 4(a) is fourier-transform infrared spectrometer (FTIR) of a LiBH₄/MgH₂ composite hydrogen storage system prepared in embodiment 1 of the present application.

FIG. 4(b) is an X-ray photoelectron spectroscopy (XPS) of a LiBH₄/MgH₂ composite hydrogen storage system prepared in embodiment 1 of the present application.

FIG. 5 is scanning electron microscope SEM) images of a LiBH₄/MgH₂ composite hydrogen storage system before and after cycling prepared in embodiment 1 of the present application and corresponding elemental site labeling images, where Before represents before cycling and After represents after cycling.

FIG. 6 is a curve of isothermal hydrogen absorption of a LiBH₄/MgH₂ composite hydrogen storage system at different temperature gradients prepared in embodiment) of the present application.

FIG. 7 is a curve of isothermal hydrogen absorption of pure MgH₂ at different temperature gradients.

FIG. 8(a) is an isothermal hydrogen absorption curve of a LiBH₄/MgH₂ composite hydrogen storage system at 300° C. for first six kinetics cycles prepared in embodiment 1 of the present application.

FIG. 8(b) is an isothermal hydrogen desorption curve of a LiBH₄/MgH₂ composite hydrogen storage system at 300° C. for first six kinetics cycles prepared in embodiment 1 of the present application.

FIG. 9(a) shows the isothermal hydrogen absorption curve of pure MgH₂ in first six kinetics cycles at 300° C.

FIG. 9(b) shows the isothermal hydrogen desorption curve of pure MgH₂ in first six kinetics cycles at 300° C.

FIG. 10(a) is an isothermal hydrogen desorption curve of a LiBH₄/MgH₂ composite hydrogen storage system prepared in embodiment 1 of the present application, pure MgH₂ and Li₂B₁₂H₁₂/MgH₂ hydrogen storage materials at 300° C. for a sixth kinetics cycle.

FIG. 10(b) is an isothermal hydrogen absorption curve of a LiBH₄/MgH₂ composite hydrogen storage system prepared in embodiment 1 of the present application, pure MgH₂ and Li₂B₁₂H₁₂/MgH₂ hydrogen storage materials at 300° C. for a sixth kinetics cycle.

FIG. 11(a) is temperature-rising hydrogen desorption curves of a LiBH₄/MgH₂ composite hydrogen storage system prepared in embodiment 1 of the present application, pure MgH₂ and MgH₂ hydrogen storage materials.

FIG. 11(b) is corresponding derivative curves of a LiBH₄/MgH₂ composite hydrogen storage system prepared in embodiment 1 of the present application, pure MgH₂ and MgH₂ hydrogen storage materials.

FIG. 12 is a high-temperature confocal micrograph of a LiBH₄/MgH₂ composite hydrogen storage system prepared in embodiment 1 of the present application, in which hydrogen is desorbed by liquid phase under high-temperature desorption.

FIG. 13 is an impedance diagram of batteries prepared by using a LiBH₄/MgH₂ composite hydrogen storage system prepared in embodiment 1 of the present application and pure MgH₂.

FIG. 14 is a diagram showing an ionic conductivity performance of the batteries prepared by using a LiBH₄/MgH₂ composite hydrogen storage system prepared in Embodiment 1 of the present application, pure MgH₂ and pure LiBH₄

### DETAILED DESCRIPTION OF THE EMBODIMENTS

A number of exemplary embodiments of the present application will now be described in detail, and this detailed description should not be considered as a limitation of the present application, but should be understood as a more detailed description of certain aspects, characteristics and embodiments of the present application.

It should be understood that the terminology described in the present application is only for describing specific embodiments and is not used to limit the present application. In addition, for the numerical range in the present application, it should be understood that each intermediate value between the upper limit and the lower limit of the range is also specifically disclosed. The intermediate value within any stated value or stated range and every smaller range between any other stated value or intermediate value within the stated range are also included in the present application. The upper and lower limits of these smaller ranges can be independently included or excluded from the range.

Unless otherwise specified, all technical and scientific terms used herein have the same meaning as commonly understood by one of ordinary skill in the field to which this application relates. Although the present application only describes the preferred methods and materials, any methods and materials similar or equivalent to those described herein can also be used in the practice or testing of the present application. All documents mentioned in this specification are incorporated by reference to disclose and describe the methods and materials related to the documents. In case of conflict with any incorporated document, the contents of this specification shall prevail.

It is obvious to those skilled in the field that many improvements and changes may be made to the specific embodiments of the present application without departing from the scope or spirit of the present application. Other embodiments will be obvious to the skilled person from the description of the application. The specification and embodiments of this application are only exemplary.

The terms “comprising”, “including”, “having” and “containing” used in this article are all open terms, which means including but not limited to.

### Embodiment 1

Preparation method of magnesium-based solid hydrogen storage material with a liquid phase regulation function includes following steps:

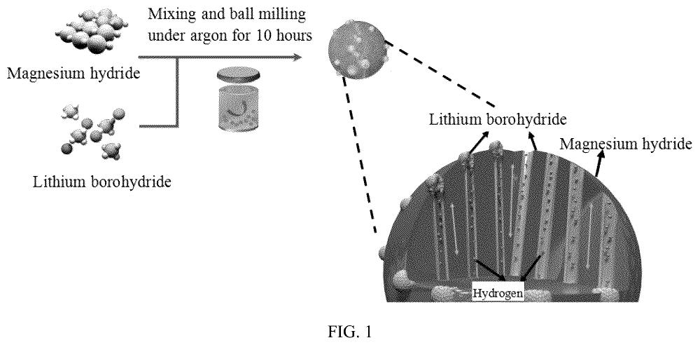

950 milligram (mg) of MgH₂ powder and 50 mg of LiBH₄ powder in a glove box filled with argon are weighed, and the MgH₂ powder and the LiBH₄ powder are put into a stainless-steel ball mill for ball milling (QM-3SP2 planetary ball mill). The technological parameters of the ball milling are as follows: ρ(O₂)<0.1 parts per million (ppm), ρ(H₂O)<0.1 ppm, a ball-to-material ratio of 40:1, steel ball diameter of 5-7 millimeter, and the rotational speed of 400 rpm, 30 min for each time of ball milling, an interval of each time of ball milling of 2 min. After ball milling, magnesium-based solid hydrogen storage material (LiBH₄/MgH₂ composite hydrogen storage system) is obtained. The preparation flow chart is shown in FIG. 1.

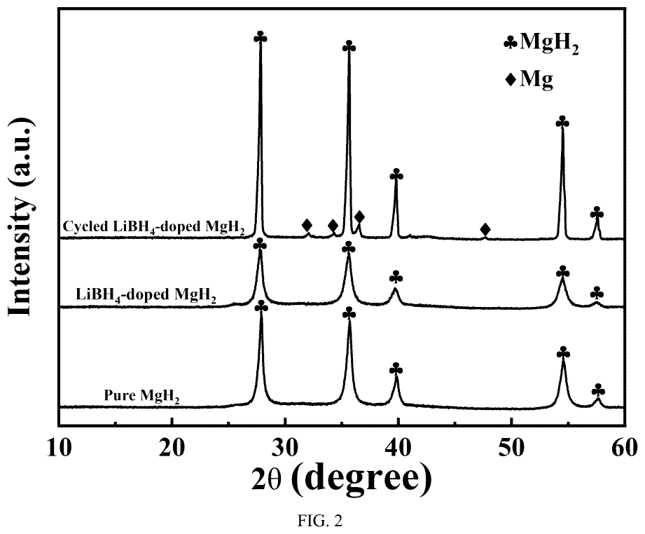

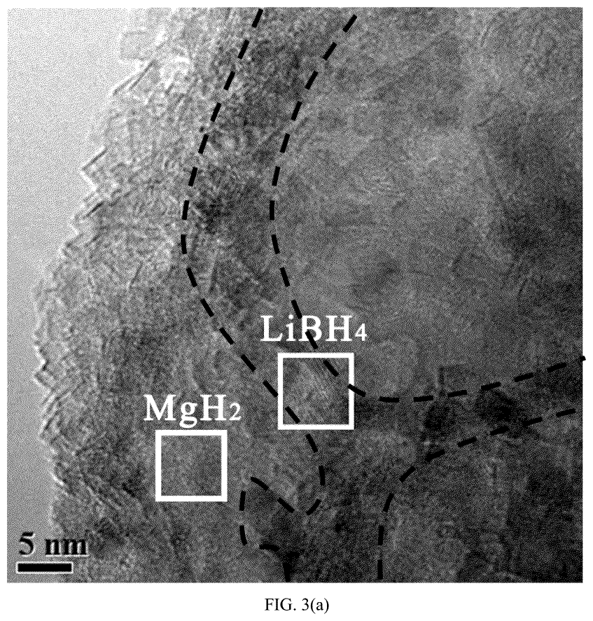

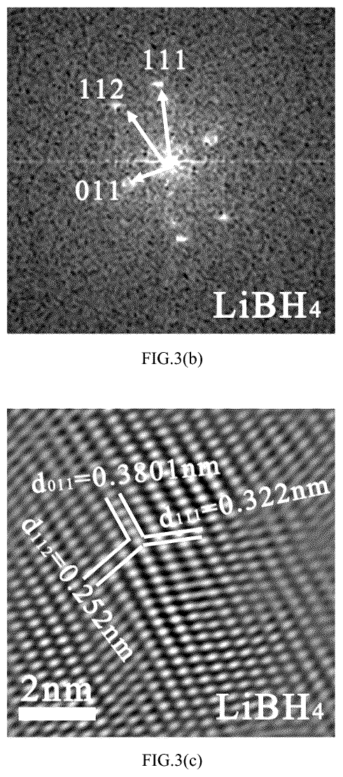

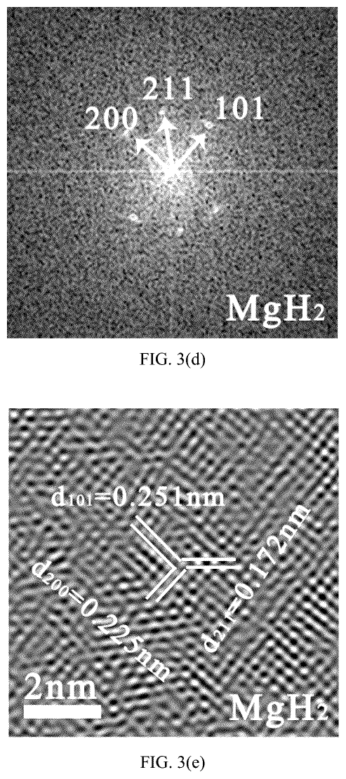

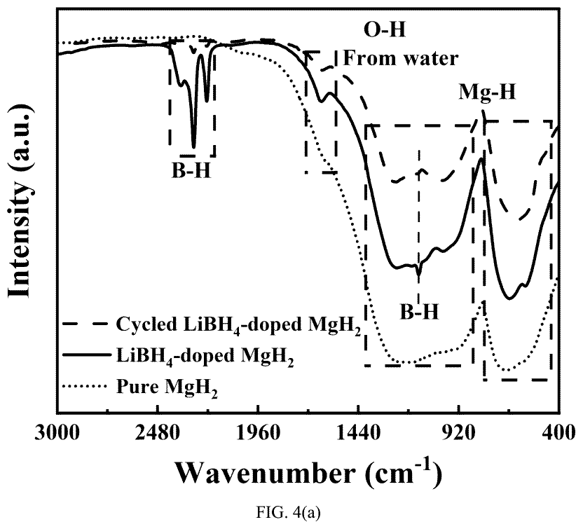

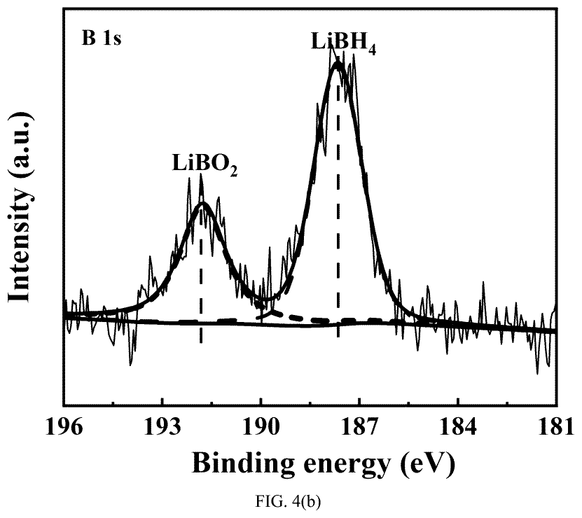

The X-ray diffraction (XRD) spectrum of LiBH₄/MgH₂ composite hydrogen storage system before and after cycling prepared in embodiment 1 of the present application is shown in FIG. 2, in which pure MgH₂ is taken as the control. Before cycling (LiBH₄-doped MgH₂) refers to the LiBH₄/MgH₂ composite hydrogen storage system without the hydrogen absorption and desorption process, and after cycling (cycled LiBH₄-doped MgH₂) refers to the LiBH₄-doped MgH₂ composite hydrogen storage system after one cycle of hydrogen absorption and desorption. See FIG. 3(a), FIG. 3(b), and FIG. 3 (e) for TEM diagram, Fourier transform diagram and lattice image. The FTIR diagram and XPS spectrum are shown in FIG. 4(a) and FIG. 4(b), in which (a) is the FTIR diagram and (b) is the XPS spectrum.

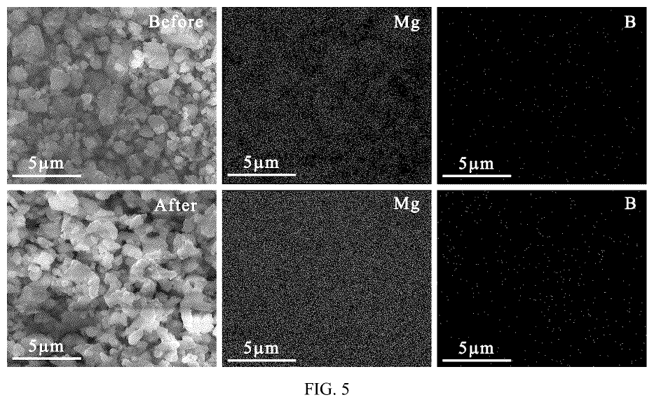

The LiBH₄/MgH₂ composite hydrogen storage system prepared in this example is subjected to one cycle of hydrogen absorption and hydrogen desorption, and the SEM images of the LiBH₄/MgH₂ composite hydrogen storage system before and after the cycle and the corresponding elemental site labeling images. The results are shown in FIG. 5, where Before is before cycling and After is after cycling.

As can be seen from FIG. 1, FIG. 2, FIG. 3(a), FIG. 3(b), FIG. 4(a) and FIG. 4(b) and FIG. 5, LiBH₄ is uniformly dispersed on the surface of MgH₂, forming a banded structure convenient for H-transfer. LiBH₄ exists stably as nanocrystalline or amorphousness during ball milling and cycling, and there is no decomposition and reaction to form a new phase before and after kinetics cycling. By observing the morphological evolution and element distribution of MgH₂ before and after cycling, it is found that the particle distribution is uniform (1-2 microns (μm) before and after cycling) and the morphology is similar, and the corresponding elements are also uniform, with the average size of 1-2 μm before and after cycling, which shows that the uniform distribution of LiBH₄ inhibits the growth of Mg grains.

0.15 gram (g) LiBH₄/MgH₂ composite hydrogen storage system is weighed in a glove box filled with argon, put into a sample chamber, and then the sealed sample chamber is evacuated and put into a resistance furnace for heating. The process parameters are: under vacuum, the temperature is raised by 5° C./min to the target temperature of 300° C., and the hydrogen pressure of 5 megapascal (MPa) is maintained during the temperature raising process to inhibit hydrogen storage and hydrogen desorption. It is found that when the LiBH₄/MgH₂ composite hydrogen storage system is heated for 40 min, the mass percentage of desorbed hydrogen is 6.7 wt % (percentage by weight).

### Comparative Example 1

Li₂B₁₂H₁₂/MgH₂ hydrogen storage material is prepared as follows;

950 mg of MgH₂ powder and 50 mg of Li₂B₁₂H₁₂ powder are weighed in the glove box filled with argon, and put into a stainless-steel ball mill for ball milling (QM-3SP2 planetary ball mill). The technological parameters of ball milling are as follows: ρ(O₂)<0.1 ppm, ρ(H₂O)<0.1 ppm, the ball-to-material ration of 40:1, the diameter of steel ball of 5-7 mm, the rotational speed of 400 rpm, ball milling of 20 times, 30 min for each ball milling, interval of each ball milling of 2 min. The Li₂B₁₂H₁₂/MgH₂ hydrogen storage material is obtained after ball milling is completed.

In the glove box filled with argon, 0.15 g Li₂B₁₂H₁₂/MgH₂ hydrogen storage material is weighed and put into a sample chamber, and then the sealed sample chamber is vacuumized and put into a resistance furnace for heating. The process parameters are: temperature is raised by 5° C./min under vacuum to the target temperature of 300° C., and the hydrogen pressure of 5 MPa is maintained during the heating process to inhibit hydrogen storage and hydrogen desorption. It is found that when the Li₂B₁₂H₁₂/MgH₂ hydrogen storage material is heated for 40 min, the mass percentage of desorbed hydrogen is 1.5 wt %.

### Comparative Example 2

MgH₂ hydrogen storage material is prepared as follows;

1000 mg of MgH₂ powder is weighted in the glove box filled with argon and put into a stainless-steel ball mill tank for ball milling (QM-3SP2 planetary ball mill). The technological parameters of ball milling are as follows: ρ(O₂)<0.1 ppm, ρ(H₂O)<0.1 ppm, the ball-to-material ratio of 40:1, the diameter of steel ball is 5-7 mm, and the rotational speed of 400 rpm, ball milling of 20 times, 30 min for each ball milling, interval of each ball milling of 2 min. The MgH₂ hydrogen storage material is obtained after ball milling is completed.

In a glove box filled with argon, 0.15 g MgH₂ hydrogen storage material is weighed and put into a sample chamber, and then the sealed sample chamber is vacuumized and put into a resistance furnace for heating. The process parameters are: under vacuum, the temperature is raised by 5° C./min to the target temperature of 300° C., and the hydrogen pressure of 5 MPa is maintained during the heating process to inhibit hydrogen storage and hydrogen desorption. It is found that when MgH₂ hydrogen storage material is heated for 40 min, the mass percentage of desorbed hydrogen is 0.3 wt %.

### Effect Example 1

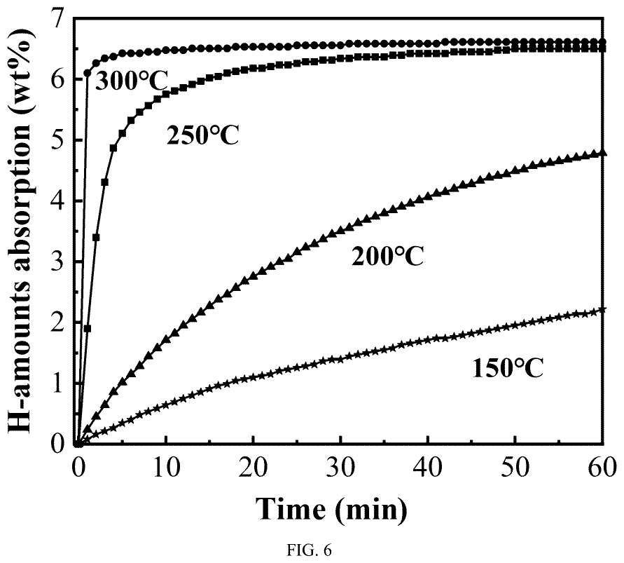

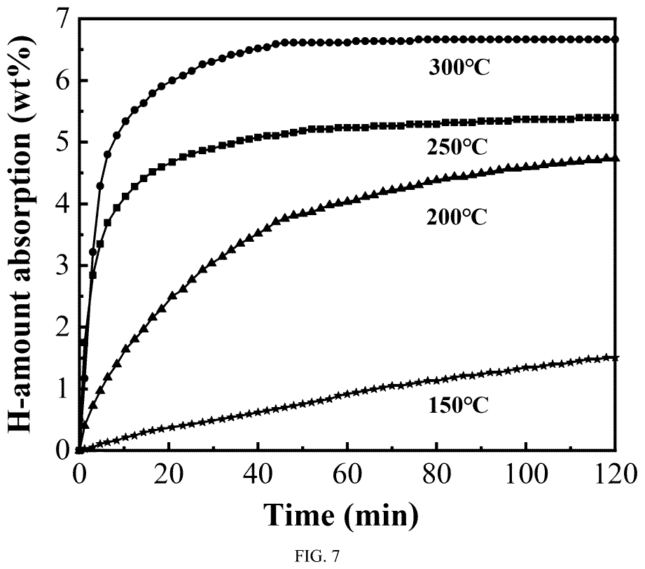

A curve of isothermal hydrogen absorption of LiBH₄/MgH₂ composite hydrogen storage system at different temperature gradients prepared in embodiment) of the present application is determined, with results shown in FIG. 6. A curve of isothermal hydrogen absorption of pure MgH₂ at different temperature gradients is determined, with results shown in FIG. 7.

As can be seen from FIG. 6 and FIG. 7, both the LiBH₄/MgH₂ composite hydrogen storage system prepared in embodiment 1 of the present application and pure MgH₂ have remarkable hydrogen absorption performance at 300° C. The LiBH₄/MgH₂ composite hydrogen storage system prepared in embodiment 1 of the present application absorbs 6.5 wt % of hydrogen within 15 min, while the pure MgH₂ in comparative example 1 absorbs 6.5 wt % of hydrogen after 40 min.

### Effect Example 2

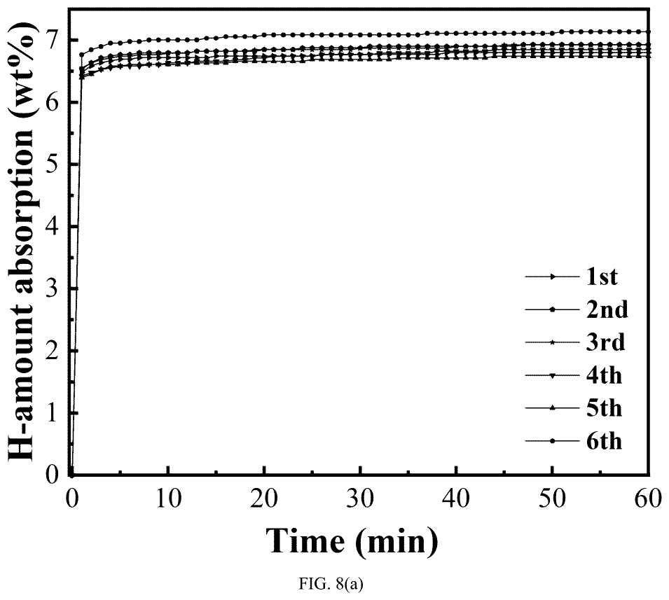

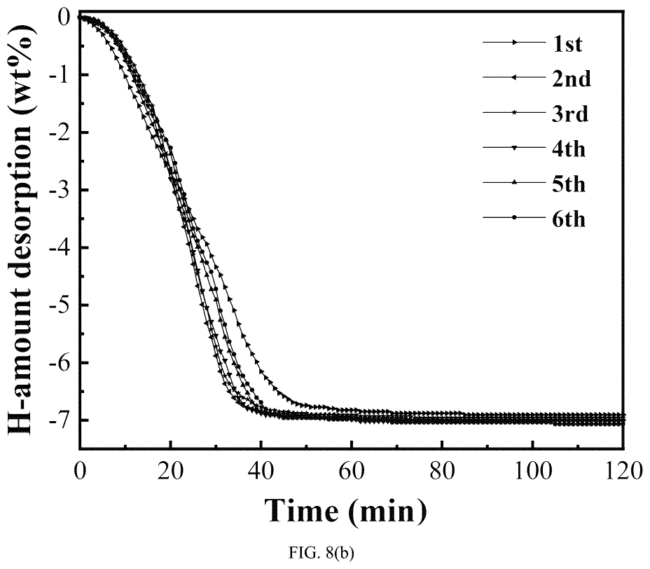

An isothermal hydrogen absorption curve of LiBH₄/MgH₂ composite hydrogen storage system at 300° C. for first six kinetics cycles prepared in embodiment 1 of the present application is determined, with results shown in FIG. 8(a). An isothermal hydrogen desorption curve of LiBH₄/MgH₂ composite hydrogen storage system at 300° C. for first six kinetics cycles prepared in embodiment 1 of the present application is determined, with results shown in FIG. 8(b).

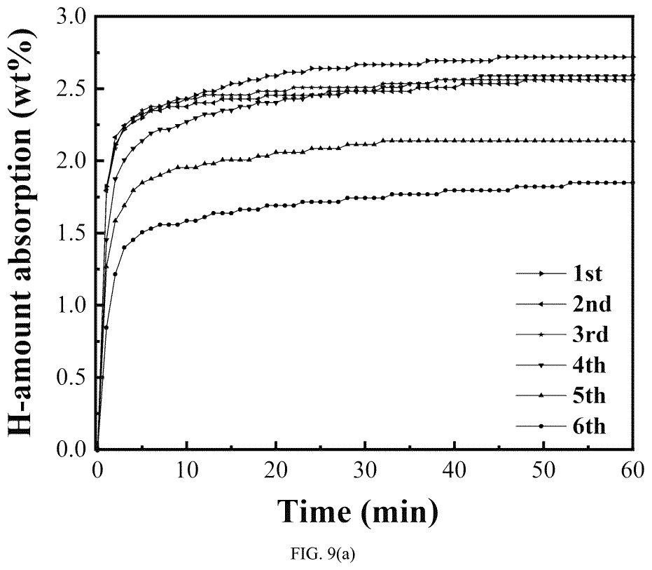

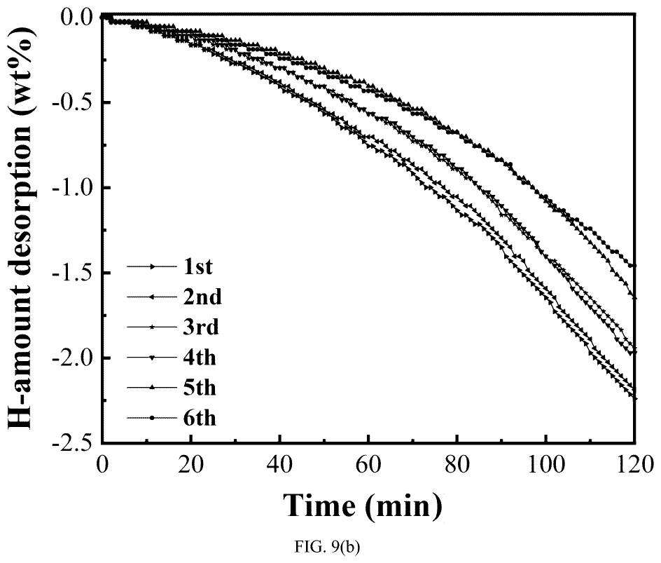

The isothermal hydrogen absorption curve of pure MgH₂ in first six kinetics cycles at 300° C. is determined with results shown in FIG. 9(a). The isothermal hydrogen desorption curve of pure MgH₂ in first six kinetics cycles at 300° C., with results shown in FIG. 9(b).

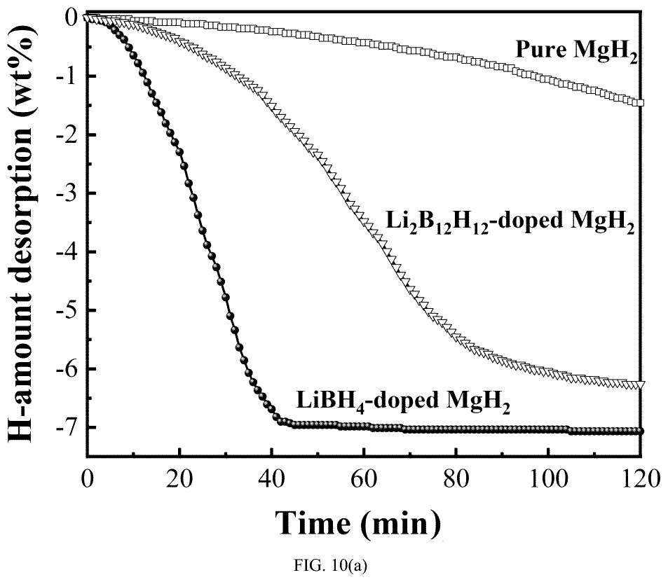

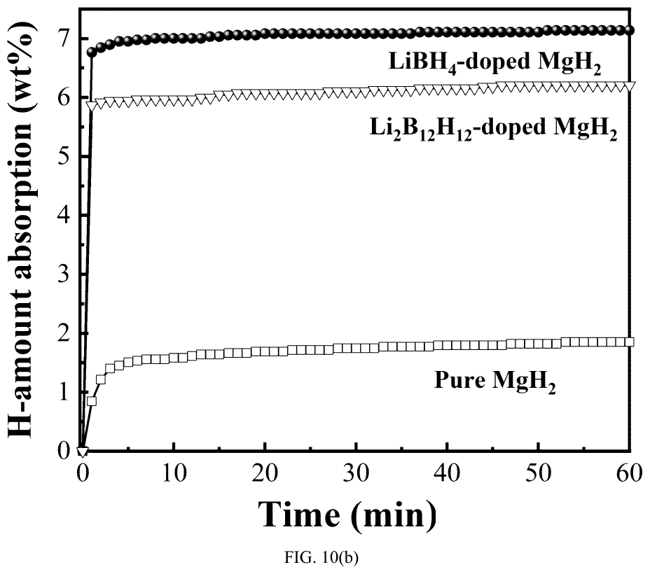

An isothermal hydrogen desorption curve of LiBH₄/MgH₂ composite hydrogen storage system prepared in embodiment 1 of the present application, pure MgH₂ and Li₂B₁₂H₁₂ hydrogen storage materials at 300° C. for the sixth kinetics cycle is determined, with results shown in FIG. 10(a).

An isothermal hydrogen absorption curve of LiBH₄/MgH₂ composite hydrogen storage system prepared in embodiment 1 of the present application, pure MgH₂ and Li₂B₁₂H₁₂/MgH₂ hydrogen storage materials (comparative example 1) at 300° C. for a sixth kinetics cycle is determined, with results shown in FIG. 10(b).

It can be seen from FIG. 8(a), FIG. 8(b), FIG. 9(a), FIG. 9(b), FIG. 10(a), FIG. 10(b) that after the LiBH₄/MgH₂ composite hydrogen storage system prepared in embodiment 1 and pure MgH₂ are tested at 300° C. for six cycles of hydrogen absorption/desorption respectively, the hydrogen absorption capacity of pure MgH₂ reaches 2.5 wt % within 10 min and the hydrogen desorption capacity of pure MgH₂ reaches 0.7 wt % in the first cycle. However, the hydrogen absorption capacity of the LiBH₄/MgH₂ composite hydrogen storage system prepared in embodiment 1 of the present application reaches 6.7 wt % within 10 min and the hydrogen desorption capacity of the LiBH₄/MgH₂ composite hydrogen storage system reaches 6.8 wt % within 40 min in the first cycle, which significantly improves the kinetics performance.

### Effect Example 3

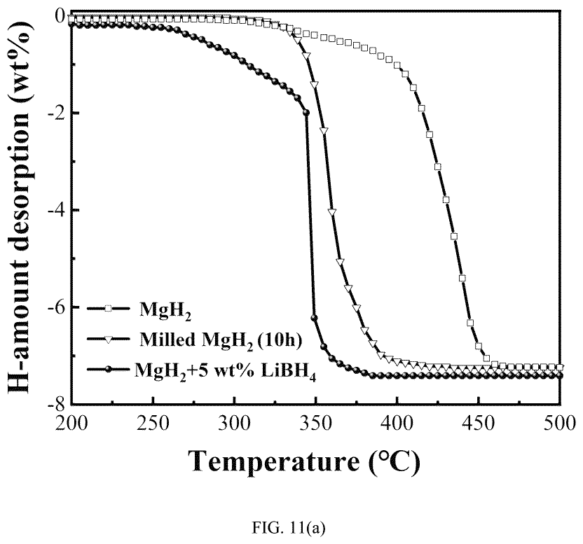

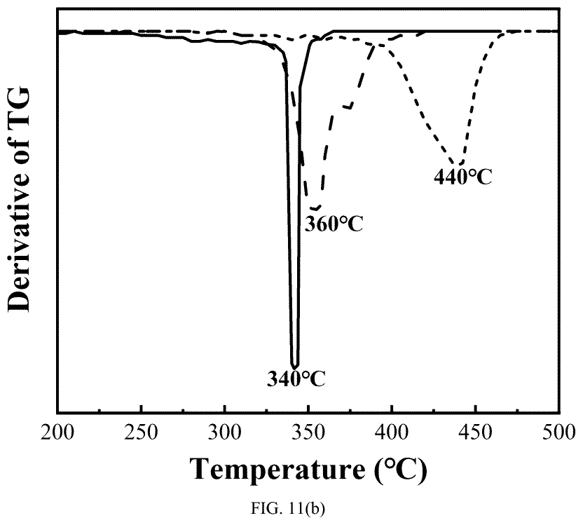

The temperature-rising hydrogen desorption performances of LiBH₄/MgH₂ composite hydrogen storage system prepared in embodiment 1 of the present application, pure MgH₂ and MgH₂ hydrogen storage material (comparative example 2) is determined, with results shown in FIG. 11(a) and FIG. 11(b). FIG. 11(a) shows temperature-rising hydrogen desorption curves. FIG. 11(b) shows corresponding derivative curves.

In FIG. 11(a) and FIG. 11(b), MgH₂ is pure MgH₂, milled MgH₂ (10 h) is MgH₂ hydrogen storage material, and MgH₂+5 wt % LiBH₄ is LiBH₄/MgH₂ composite hydrogen storage system.

As can be seen from FIG. 11(a) and FIG. 11(b), the peak dehydrogenation temperature of the LiBH₄/MgH₂ composite hydrogen storage system prepared by the application is 340° C., the peak dehydrogenation temperature of the MgH hydrogen storage material is 360° C., and the peak dehydrogenation temperature of the pure MgH₂ is 440° C.

### Effect Example 4

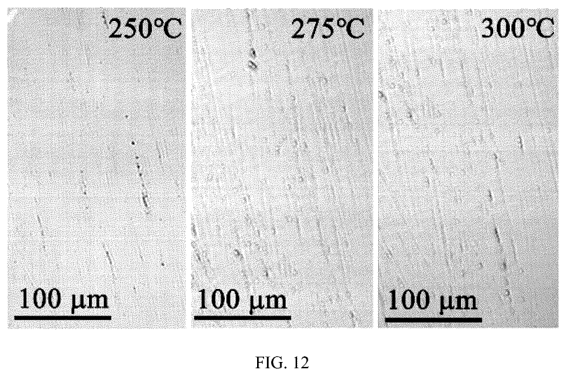

The microstructure of the LiBH₄/MgH₂ composite hydrogen storage system prepared in embodiment 1 of the present application was measured at high temperature, and the results are shown in FIG. 12 (high temperature confocal micrograph).

As can be seen from FIG. 12, LiBH₄ in the LiBH₄/MgH₂ composite hydrogen storage system prepared in embodiment 1 of the present application presents a liquid phase at high temperature, so that hydrogen is precipitated from the liquid borohydride phase in the form of bubbles, and compared with the solid phase with low relative migration energy, hydrogen moves rapidly in the liquid phase, thus improving the hydrogen desorption rate, and at the same time, the introduction of LiBH₄ may provide more diffusion paths as a channel for diffusion.

### Effect Example 5

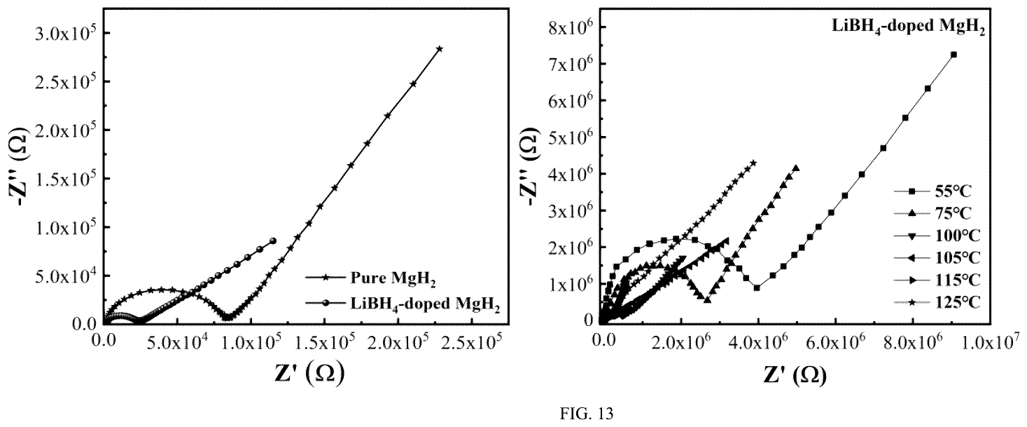

The LiBH₄/MgH₂ composite hydrogen storage system prepared in Embodiment 1 of the present application and pure MgH₂ are respectively prepared as positive electrode materials for all-solid-state batteries, and the impedance performance of the batteries is determined. The results are shown in FIG. 13, in which Pure MgH₂ is pure MgH₂ and LiBH₄-doped MgH₂ is the LiBH₄/MgH₂ composite hydrogen storage system prepared in Embodiment 1 of the present application.

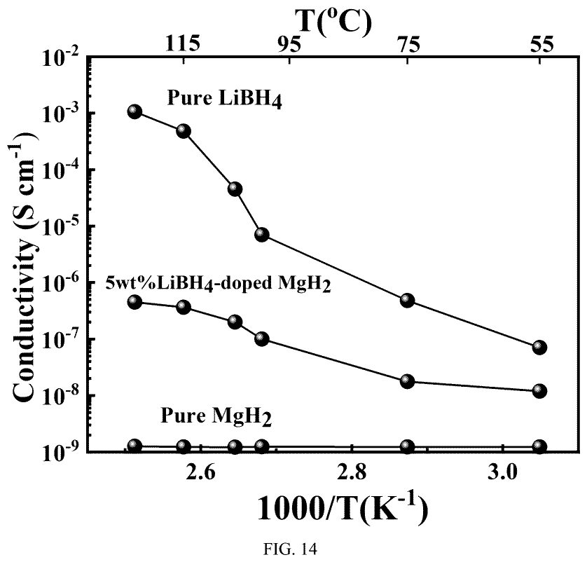

The LiBH₄/MgH₂ composite hydrogen storage system prepared in Embodiment 1 of the present application, pure MgH₂ and pure LiBH₄ are respectively prepared as positive electrode materials for all-solid-state batteries, and the ionic conductivity of the batteries is determined. The results are shown in FIG. 14. In FIG. 14, Pure LiBH₄ is pure LiBH₄, 5 wt % LiBH₄-doped MgH₂ is the LiBH₄/MgH₂ composite hydrogen storage system prepared in Embodiment 1 of the present application, and Pure MgH₂ is pure MgH₂.

The preparation method of positive electrode materials of all-solid-state batteries is as follows:

120 mg of the above materials are weighed in a glove box filled with argon gas respectively and pressed for 5 min under the pressure of 7 MPa to obtain the positive electrode materials of all-solid-state batteries, and the button-type all-solid-state batteries are assembled in the glove box filled with argon gas, with metal lithium sheets as the negative electrode materials and LiBH₄ as the electrolyte.

As can be seen from FIG. 13, compared with the battery prepared by pure MgH₂, the battery prepared by the LiBH₄/MgH₂ composite hydrogen storage system prepared by the embodiment 1 of the present application has a reduced impedance from 8.39×10⁴Ω (ohm) to 2.42×10⁴Ω, and the resistance of the battery prepared by the LiBH₄/MgH₂ composite hydrogen storage system prepared by the embodiment 1 of the present application gradually decreases with the increase of temperature, and the corresponding resistance value is decreased to 1.05×10⁵Ω from 4×10⁶Ω at 55° C.

With the introduction of LiBH₄, MgH₂ is changed to a conductor from an insulator. As can be seen from FIG. 14, the ionic conductivity of the LiBH₄/MgH₂ composite hydrogen storage system prepared in embodiment 1 of the present application is 3.2×10⁻⁷ S/cm (siemens per centimeter).

The above-mentioned embodiments only describe the preferred mode of the application, and do not limit the scope of the application. Under the premise of not departing from the design spirit of the application, various modifications and improvements made by ordinary technicians in the field to the technical scheme of the application shall fall within the protection scope determined by the claims of the application.

What is claimed is:

1. A magnesium-based solid hydrogen storage material with a liquid phase regulation function, comprising following raw materials in percentage by mass: 95% of magnesium hydride and 5% of lithium borohydride.

2. A preparation method of the magnesium-based solid hydrogen storage material with a liquid phase regulation function according to claim 1, comprising following steps: mixing raw materials in an inert gas atmosphere according to the mass percentage, and performing ball milling to obtain the magnesium-based solid hydrogen storage material.

3. The preparation method of the magnesium-based solid hydrogen storage material with a liquid phase regulation function according to claim 2, wherein a ball-to-material ratio for the ball milling is 40.1.

4. The preparation method of the magnesium-based solid hydrogen storage material with the liquid phase regulation function according to claim 2, wherein a number of times of the ball milling is 20, and the duration of each ball milling is 30 minutes.

5. The preparation method of the magnesium-based solid hydrogen storage material with a liquid phase regulation function according to claim 2, wherein a diameter of a steel ball used in the ball milling is 5-7 millimeters; and a rotational speed of the ball milling is 400 revolutions per minute.

6. An application of the magnesium-based solid hydrogen storage material with a liquid phase regulation function according to claim 1 in preparing a hydrogen storage material.
